(19) United States
(12) Patent Application Publication
(10) Pub. No.: US 2024/0015871 A1
(43) Pub. Date: Jan. 11, 2024

(54) WIRELESSLY CONNECTED LIGHTS

(71) Applicant: Mahmoud Moustafa Ibrahim Mokhtar Elbanhawi, Dubai (AE)

(72) Inventor: Mahmoud Moustafa Ibrahim Mokhtar Elbanhawi, Dubai (AE)

(21) Appl. No.: 17/859,100

(22) Filed: Jul. 7, 2022

(51) Int. Cl. H05B 47/155; H05B 47/19; F21L 4/02; F21L 2/00; F21L 14/02

(52) U.S. Cl. CPC H05B 47/155; H05B 47/19; F21L 4/02; F21L 2/00; F21L 14/023

(57) ABSTRACT

In one aspect, the invention provides a set of connected lights. The lights comprise an illumination panel having a single colored or a multi-colored LED. The lights are connected to each other directly through any known means, such as RFID, Zigbee, WLAN, WWAN, Bluetooth, Infrared, and the like, and combinations thereof. Each light is operated using a touch sensor, a motion sensor, a gesture sensor, etc. When a state of any one of the lights changes, the states of all the other connected lights are automatically synchronized. The states include at least one of on and off, or alternatively off and on in any one of multiple options of color, etc. Each color is associated with a specific message, and the connected lights may be used to transmit and receive messages accordingly. Thus, the invention also provides a method of transmitting and receiving messages using the connected lights.

### TECHNICAL FIELD OF THE INVENTION

The invention relates generally to wirelessly connected lights and more specifically to wirelessly connected lights that are synchronized to send a preset message.

### BACKGROUND

Connected lights generally involve lights that are connected through a centralized processor that comprises a controller. This then senses the light requirement of a certain region, and then controls the lights of that region according to the requirement. In some instances, the controller is associated with one of the lights, which becomes a master light, and all other connected lights become a slave light.

Typically, connected lights involve connecting through the controller. The connection may then be routed through a communication network, which may even include the use of the internet or a mobile network. Thus, lights distributed across any location around the world may then be suitably connected to light up in a synchronized manner

Such connected lights are used in many situations. For example, connected lights are used in a restaurant wherein a light on a table is connected to a light in the kitchen, such that when the table light is turned on, the kitchen light is also turned on, thus indicating to the wait staff about a certain requirement. Similarly, friendship lamps that are suitably synchronized through the internet is also known in the art.

In all these instances, one of the lights is a master light, while the other connected lights are slave lights. Thus, the master light dictates the state of all the connected slave lights.

There is a need in the art for a set of connected lights that are non-specific in the direction of instructions whilst retaining all the connected lights in a synchronized state at all times.

### BRIEF DESCRIPTION OF THE INVENTION

In one aspect, the invention provides a connected set of lights comprising a plurality of lights, wherein each light comprises a housing to house a power source and an illumination panel powered by the power source, wherein each light is connected to the other lights directly wirelessly.

In another aspect, the invention provides a connected set of lights comprising a plurality of lights described herein, wherein each light is connected to the other lights directly wirelessly. Each light transmits its state to the other connected lights to synchronize the states of the connected lights.

In yet another aspect, the invention provides a method of operating a set of connected lights, each light comprising a housing to house a power source and an illumination panel powered by the power source, wherein each light is connected to the other lights directly wirelessly, wherein each light comprises at least one sensor; operating a first light through the sensor to change its state, and automatically operating the other connected lights to synchronize their respective states.

### BRIEF DESCRIPTION OF THE FIGURES

These and other features, aspects, and advantages of the present invention will become better understood when the following detailed description is read with reference to the accompanying drawings in which like characters represent like parts throughout the drawings, wherein:

FIG. 1 is an image of one exemplary light of a plurality of connected lights of the invention.

FIG. 2 is an image of an exemplary pair of connected lights of the invention.

FIG. 3 is an image of a light of the invention that comprises a touch sensor being operated by a user's finger.

FIG. 4a shows a pair of connected lights, wherein one of the lights is being actuated by a touch sensor.

FIG. 4b shows a pair of connected lights wherein both lights are synchronized to glow in a specific color.

FIG. 5 shows one embodiment of the attachment means made available on the back of the connected light, and a corresponding attachment means made available on a wall.

### DETAILED DESCRIPTION

The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the term “or” is generally employed in its sense including “and/or” unless the content clearly dictates otherwise.

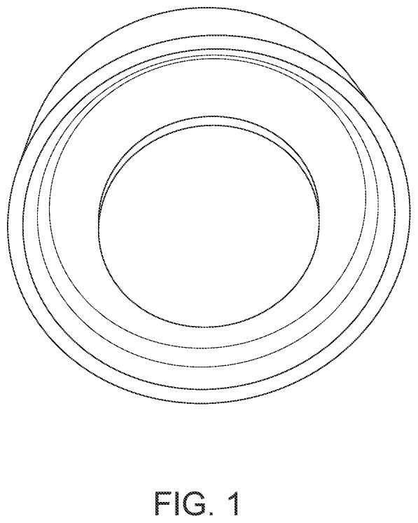

As noted herein, in one aspect the invention provides a connected set of lights. Each light in the set of lights comprises a housing to house a power source and an illumination panel powered by the power source. The housing is made of a translucent plastic material known in the art that can provide diffused lighting when the illuminating panel is lit up. Further, each light is connected to the other lights directly wirelessly. The illumination panel comprises a set of lighting elements, which may be made from a single-colored LED lamps or a set of multi-colored LED lamps. FIG. 1 shows one light of the invention.

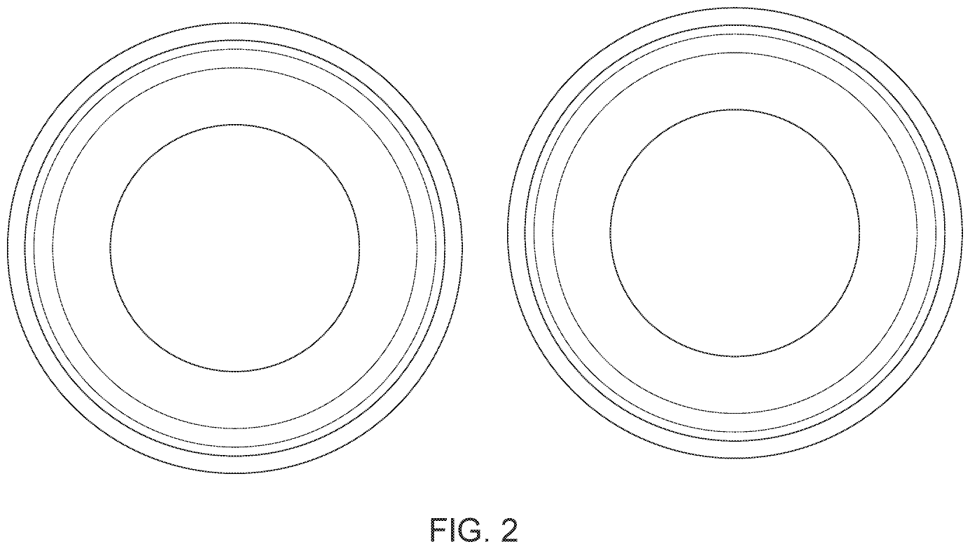

Each light is connected to the other lights through a direct wireless connection that is least one of Wi-Fi direct, Bluetooth, infrared, wireless wide area network (WWAN), wireless local area network (WLAN), RFID, Zigbee, and combinations thereof. Thus, each light comprises a transmitter and receiver such that it can transmit its state to the other connected lights, and receive the state from the other's lights also. In this manner, when one light is switched on to a specific color, the other connected lights are also switched on to the same color immediately. FIG. 2 shows a pair of connected lights.

The power source comprises at least one rechargeable battery. In some embodiments, the rechargeable battery can be recharged through a recharging port well-known in the art. One exemplary recharging port includes a USB port. Another exemplary recharging port includes wireless chargers. Other recharging ports are also known in the art and are contemplated to be within the scope of the invention.

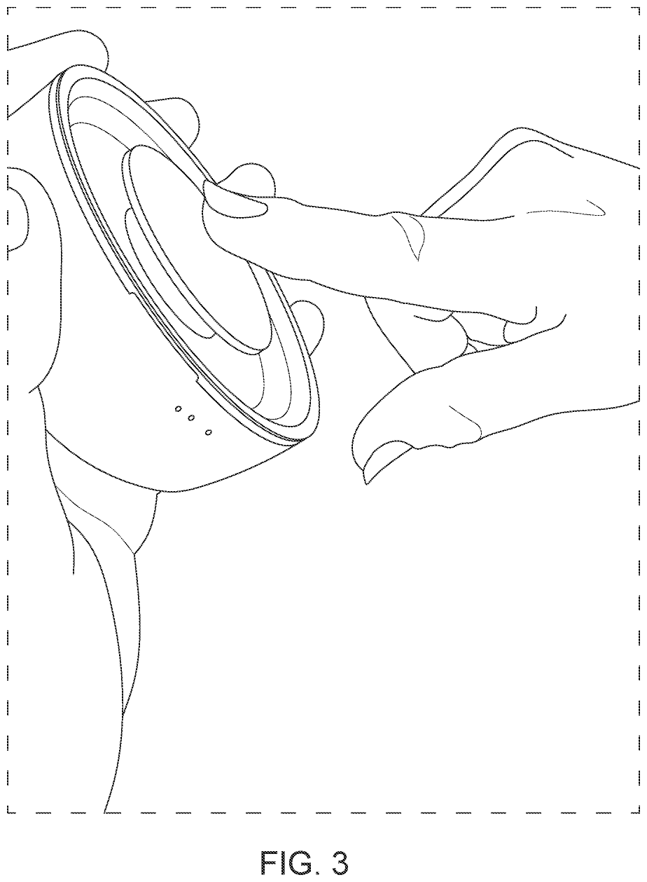

Each light in the set of lights comprises at least one sensor, which may include at least one of a touch sensor, acoustic sensor, gesture sensor, motion sensor, and combinations thereof. In one exemplary embodiment, the lights comprise a touch sensor. FIG. 3 shows a light of the invention comprising a touch sensor that is being operated by a user's finger. Thus, when one of the lights is touched to switch it on, all the other connected lights are also automatically switched on immediately. In another exemplary embodiment, the sensor may be a gesture sensor that is configured to recognize at least one gesture. Gestures may include at least one wave, hand motion, and the like, and combinations thereof. Similarly, acoustic sensors may be configured to recognize sounds such as a finger snap, clap, etc. In further exemplary embodiments, sensor may be a motion sensor configured to recognize any movement that indicates the presence of a human in the vicinity.

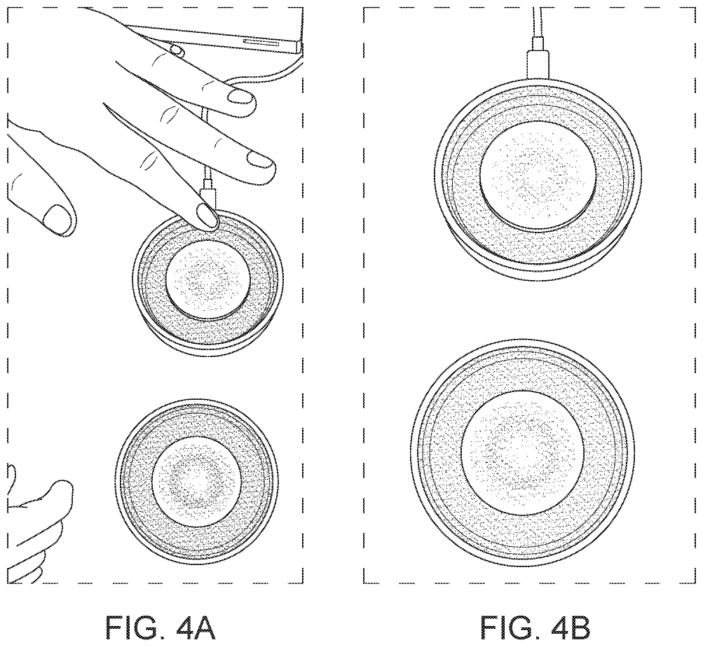

Once one of the lights is actuated by a sensor, the light then transmits its state to the other connected lights within the vicinity, following which the other connected lights also synchronize its state to the first light. FIG. 4a shows a pair of connected lights, wherein one of the lights is being actuated by a touch sensor.

Each light in the connected set of lights is associated with a state. Each light transmits its state to the other connected lights to synchronize the states of the connected lights. In one exemplary embodiment, the state is one of on or off. Thus, all the lights may be in off state or they may be in an on state configured to glow in any color. In another exemplary embodiment, the state of the lights is on to glow in any one of multiple options of color . Thus, when one of the lights is switched on to a certain color, all the other connected lights are synchronized to that same color. In the exemplary embodiment shown in FIG. 4b, both lights are synchronized to glow in a specific color. One skilled in the art will understand that LED lamps may be configured to glow in different colors by the appropriate use of the sensor. For example, a single touch may turn on the blue color, while two rapid touches may turn on green, while three rapid touches may turn on red, and so on.

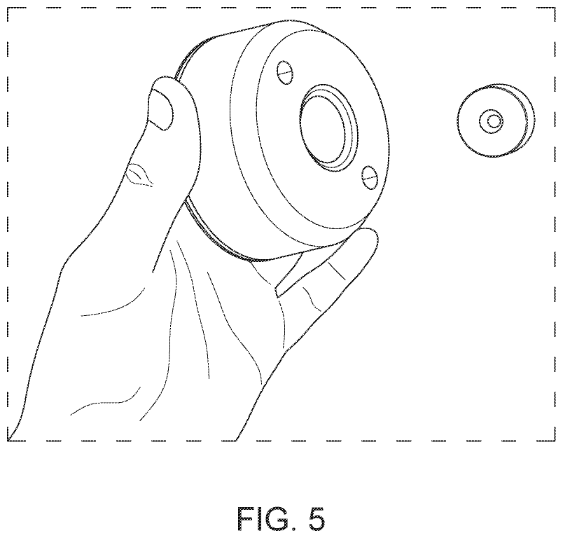

Each light may further comprise attachment means at a suitable location on the light. This attachment means will enable the light to be attached to a particular location, such as a wall, on a table, on a door etc. Attachment means known in the art include, at least one of an adhesive backing, a magnetic back, double sided adhesive tape, hook and loop fastener (known commonly in the art as Velcro®), and the like, and combinations thereof. FIG. 5 shows one embodiment of the attachment means made available on the back of the connected light, and a corresponding attachment means made available on a wall. In one specific embodiment, a magnetic attachment means is provided to secure the connected light onto the wall.

In another aspect, the invention provides a method of operating the set of connected lights described in the invention to convey a preset message associated with every state of the lights. Thus, in this manner, the invention enables a method of conveying a preset message comprising associating at least one state of a light to the preset message by operating a first light through the sensor to enable one of the at least one state and synchronizing the state of the other connected lights to that of the first light, and consequently conveying the preset message.

State may include Off to indicate no message, On to indicate ‘Do Not Disturb’. Further, multiple states may be used to convey different messages. For example, a Red light may be used to indicate ‘Do Not Disturb’, Green light to indicate ‘Allow the next person’, Blue light to indicate ‘Out of Office’, and so on. Further, such lights can enable communication between individuals or groups of individuals. For example, one individual inside an office can tap the light to turn on green color that has pre-assigned a message “My current meeting is over”. Following this, another individual in possession of the other connected light can tap the light to turn on a blue color that has pre-assigned a message “I am sending the next person in.”

Different states may be enabled by different gestures. For example, a single tap may be used to turn on the light, two short double taps may be used to change light color, a long tap may be used to turn off, and so on. Alternately, a clap may be used to turn on the light, while two short claps may be used to change light color, three short claps may be used to turn off, and so on. More such variations in gestures, touches, acoustics etc. will become obvious to one of ordinary skill in the art, and is envisioned to be encompassed within the scope of the invention.

Thus, the invention also provides a system of communicating between individuals or groups of individuals through the use of the connected lights, wherein the lights are connected to each other directly wirelessly. It would also become obvious to one skilled in the art that the illumination panel can be illuminated in such a way to spell words to convey messages.

The set of connected lights of the invention can find tremendous use in various situations, such as, but not limited to, offices to communicate between bosses and assistants, doctors' offices, hotel rooms, restaurants, and so on.

Thus, the invention provides a set of connected lights that synchronize their respective states by wirelessly connecting to each other directly. Once each state is assigned a predetermined message, the set of connected lights may be used to convey messages to each other. Further, the set of connected lights can also be used to communicate through a series of messages between individuals or groups of individuals.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A connected set of lights comprising a plurality of lights, wherein each light comprises a housing to house a power source and an illumination panel powered by the power source, wherein each light is connected to the other lights directly wirelessly, wherein each light is associated with a state, and the states of all the connected lights are synchronized.

2. The connected set of lights of claim 1 wherein the power source comprises at least one rechargeable battery

3. The connected set of lights of claim 1 wherein each light comprises a recharging port to recharge the at least one rechargeable battery

4. The connected set of lights of claim 1 wherein the wireless connection is at least one of Wi-Fi direct, Bluetooth, infrared, wireless wide area network (WWAN), wireless local area network (WLAN), RFID, Zigbee, and combinations thereof.

5. The connected set of lights of claim 1 wherein each light further comprises at least one sensor, wherein the at least one sensor is a touch sensor, acoustic sensor, gesture sensor, motion sensor, and combinations thereof.

6. The connected set of lights of claim 1 wherein the illumination panel comprises at least one LED light source.

7. A connected set of lights comprising a plurality of lights, wherein each light is associated with a state, and comprises a housing to house:
a power source,
a wireless transmitter,
a wireless receiver, and
an illumination region powered by the power source;
wherein each light is connected to the other lights directly wirelessly, wherein each light transmits its state to the other connected lights to synchronize the states of the connected lights.

8. The connected set of lights of claim 7 wherein the state is one of on or off.

9. The connected set of lights of claim 7 wherein the state is one of off, or to glow in any one of multiple options of color.

10. The connected set of lights of claim 7 wherein each light further comprises at least one sensor, wherein the at least one sensor is a touch sensor, acoustic sensor, gesture sensor, motion sensor, and combinations thereof.

11. The connected set of lights of claim 7 wherein the power source comprises at least one rechargeable battery.

12. The connected set of lights of claim 11 wherein each light comprises a recharging port to recharge the at least one rechargeable battery.

13. The connected set of lights of claim 7 wherein the wireless connection is at least one of Wi-Fi direct, Bluetooth, infrared, wireless wide area network, wireless local area network, RFID, Zigbee, and combinations thereof.

14. The connected set of lights of claim 7 wherein the illumination panel comprises at least one LED light source.

15. A method of operating a set of connected lights, each light comprising a housing to house a power source and an illumination panel powered by the power source, wherein each light is connected to the other lights directly wirelessly, wherein each light comprises at least one sensor; wherein the method comprises operating a first light through the sensor to change its state, and automatically operating the other connected lights to synchronize their respective states.

16. The method of claim 15 wherein the state is one of on or off.

17. The method of claim 15 wherein the state is one of off, or, to glow in any one of multiple options of color.

18. The method of claim 15 wherein the at least one sensor is a touch sensor, acoustic sensor, gesture sensor, motion sensor, and combinations thereof.

19. The method of claim 15 wherein the power source comprises at least one rechargeable battery.

20. The method of claim 15 wherein each light comprises a recharging port to recharge the at least one rechargeable battery.

21. The method of claim 15 wherein the wireless connection is at least one of Wi-Fi direct, Bluetooth, infrared, wireless wide area network, wireless local area network, RFID, Zigbee, and combinations thereof.

22. The method of claim 15 wherein the illumination panel comprises at least one LED light source.

23. The method of claim 15, wherein each state is used to convey a preset message.
